(19) United States
(12) Patent Application Publication
(10) Pub. No.: US 2011/0102430 A1
(43) Pub. Date: May 5, 2011

(54) SYSTEM AND METHOD FOR PRESENTING TOMOSYNTHESIS IMAGES

(75) Inventors: Jeffrey Wayne Eberhard, Albany, NY (US); Peter Michael Edic, Albany, NY (US); Bernhard Erich Hermann Claus, Niskayuna, NY (US); Robert August Kaucic, Niskayuna, NY (US)

(73) Assignee: GENERAL ELECTRIC COMPANY, SCHENECTADY, NY (US)

(21) Appl. No.: 12/609,071

(22) Filed: Oct. 30, 2009

(51) Int. Cl. H04N 13/02; G06T 17/00; G06K 9/46

(52) U.S. Cl. 345/420; 382/190; 348/46; 382/128; 348/E05.031

(57) ABSTRACT

A method and system for presenting images of an object of interest is provided. The method includes producing one or more cine loops of images from at least one of multiple projection views or multiple reconstructed 3D images including a 3D volume obtained from one or more beamlines. The method also includes generating at least one combined image including a first component and a second component wherein the first component and the second component each include one of a baseline image or the one or more cine loops of images. The combined image is generated via at least one of superimposing the first component and the second component, displaying the first component adjacent to the second component, and toggling between the first component and the second component. The method also includes displaying the at least one combined image.

### BACKGROUND

The invention relates generally to tomosynthesis imaging and more particularly, to presentation of information from tomosynthesis imaging.

Tomosynthesis imagery, commonly used in security applications and medical applications, is a three-dimensional imaging technique using limited-angle tomography. This technique makes it possible to reconstruct a three-dimensional (3D) volume from a series of two-dimensional (2D) projection images acquired using an X-ray source and detector at different angular orientations relative to the object/patient to be scanned.

Typically, in security applications, an operator attempts to identify objects of interest within a baggage via an imaging technique. Some baggage inspection systems commonly use simple projection X-ray imaging systems that are completely dependent on interpretation by an operator. More sophisticated systems use dual-view, multi-view arrangements, or computed tomography (CT). Some of these systems utilize detection algorithms to automatically recognize certain types of threats and/or contraband.

In general, baggage inspection systems using projection X-ray images employ one or two views and require operators to review the images for objects of interest such as drugs, explosives, contraband, nuclear and shielding materials. However, the limited number of views obtained do not provide the operator adequate means for identifying the objects accurately, thus leading to dependency upon the operator's interpretation and an increase in inspection times.

Accordingly, there is a need for an improved means to present images obtained from imaging systems that can adequately assist the operators.

### BRIEF DESCRIPTION

In accordance with an embodiment of the invention, a method for presenting images of an object of interest is provided. The method includes producing one or more cine loops of images from at least one of multiple projection views or multiple reconstructed images including a 3D volume obtained from one or more beamlines. The method also includes generating at least one combined image including a first component and a second component, wherein the first component and the second component each include one of a baseline image or the one or more cine loops of images, the generating including at least one of superimposing the first component and the second component, or displaying the first component adjacent to the second component, or toggling between the first component and the second component. The method also includes displaying the at least one combined image.

In accordance with another embodiment of the invention, an imaging system for an object of interest is provided. The imaging system includes a radiation source configured to emit a stream of radiation through the object of interest at a plurality of projection directions. The imaging system also includes at least one detector array including multiple detector elements, wherein each detector element is configured to generate one or more signals in response to respective streams of radiation, and wherein the one or more signals convey information about the object at respective orientation angles of each detector element relative to the object. The imaging system also includes a processor coupled to the detector array. The processor is configured to receive the one or more signals, generate projection views from the one or more signals, and reconstruct images including a 3D volume and slices thereof of the 3D volume from the projection views. The processor is also configured to produce one or more cine loops of images at least one of a plurality of the projection views or a plurality of reconstructed images including a 3D volume obtained from one or more beamlines. The processor is further configured to generate at least one combined image including a first component and a second component, wherein the first component and the second component each include one of a baseline image or the one or more cine loops of images and the generating includes at least one of superimposing the first component and the second component, or displaying the first component adjacent to the second component, or toggling between the first component and the second component. The imaging system also includes an operator workstation configured to display the at least one combined image.

In accordance with another embodiment of the invention, a method for presenting images of an object of interest is provided. The method includes producing multiple reconstructed images including a 3D volume or a baseline image for one or more beamlines. The method also includes generating at least one combined image including a first component and a second component, wherein the first component and the second component, each include one of a baseline image or the multiple reconstructed images including a 3D volume and the generating includes at least one of superimposing the first component and the second component, displaying the first component adjacent to the second component, and toggling between the first component and the second component. The method also includes displaying the at least one combined image.

In accordance with another embodiment of the invention, a system for presenting images of an object of interest is provided. The system includes a radiation source configured to emit a stream of radiation through the object of interest at multiple projection directions. The system also includes at least one detector array having multiple detector elements, wherein each detector element is configured to generate one or more signals in response to respective streams of radiation, and wherein the one or more signals convey information about the object at respective orientation angles of the radiation source and detector array relative to the object. The system also includes a processor coupled to the detector array. The processor is configured to receive the signals, generate projection views from the signals, reconstruct images including a 3D volume and slices thereof of the 3D volume, from the projection views. The processor is also configured to at least one of superimpose a first component and a second component, displaying the first component adjacent to the second component or toggling between the first component and the second component to generate at least one combined image, wherein the first component and the second component each comprise one of a baseline image or the plurality of reconstructed images comprising the 3D volume The system also includes an operator workstation configured to display the at least one combined image.

In accordance with another embodiment of the invention, a system for presenting images of an object of interest is provided. The system includes a processor coupled to at least one detector array. The processor is configured to receive one or more signals from a detector array, generate projection views from the one or more signals, and reconstruct images of the object from the projection views. The processor is also configured to produce one or more cine loops of multiple images, or multiple projection views or multiple reconstructed images including a 3D volume. The processor is also configured to at least one of superimpose a first component and a second component, displaying the first component adjacent to the second component or toggling between the first component and the second component to generate at least one combined image, wherein the first component and the second component each include one of a baseline image or a cine loop of the plurality of images. The system also includes an operator workstation configured to display the at least one combined image.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an exemplary tomography system in accordance with an embodiment of the invention.

FIG. 2 is a schematic representation of image displayed from the tomographic system in FIG. 1 along a first beamline direction.

FIG. 3 is a schematic representation of image displayed from the tomographic system in FIG. 1 along a second beamline direction.

FIG. 4 is a schematic representation of a volume rendering of the object being imaged from the tomographic system in FIG. 1.

FIG. 5 is a flow chart representing steps in an exemplary method for presenting images of an item of interest in accordance with an embodiment of the invention.

FIG. 6 is a flow chart representing steps in another exemplary method for presenting images of an item of interest in accordance with an embodiment of the invention.

### DETAILED DESCRIPTION

As discussed in detail below, embodiments of the invention includes a system and method for presentation of tomosynthesis imaging in, for example, inspection of threat material in objects. As used herein, the term ‘objects’ refers to luggage, parcels, and the like. Non-limiting applications of the technique may be contraband detection, medical applications, and industrial inspection.

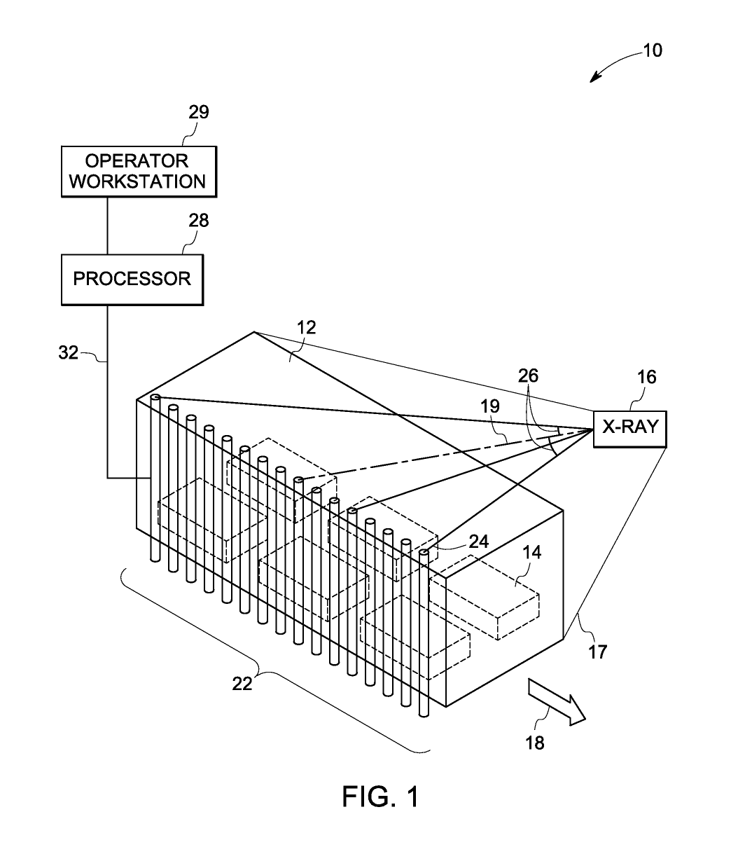

FIG. 1 is a diagrammatic illustration of an exemplary imaging system 10. The imaging system 10 may also be referred to as an inspection system. The imaging system 10 inspects the object 12. In the illustrated embodiment, the object 12 is a container or baggage including one or more items of interest 14. In one example, items of interest include contraband or explosives. In another example, items of interest include special nuclear material or shielding material. At least one radiation source 16 operating at a single or multiple energies transmits a radiation beam 17 toward the object 12. In a particular embodiment, the radiation source 16 includes an X-ray source, gamma ray emitting radioactive source or a neutron source. In another embodiment, the source 16 includes a dual-energy source providing operating voltages between about 200 kVp (kilo-Volts peak voltage) and about 80 kVp. As shown, the radiation source 16 is also configured to be stationary while the object 12 moves in a translational direction 18. In an exemplary embodiment, the radiation source 16 and the detector system 22 are stationary while the object 12 moves in a translational direction 18. In an alternative embodiment, the radiation source 16 and the detector system 22 actuate in a translational direction 18 relative to the object 22, which may be stationary.

A detector system 22 receives multiple radiation beams 24 transmitted through the objects 12 and items of interest 14. The detector system 22 includes individual detector arrays, which are oriented at different orientation angles 26 with respect to a central radiation beam axis or beamline 19 from the source 16. In the illustrated embodiment, the detector system 22 includes multiple linear detector arrays. The angular spacing between these linear detector arrays enables the system 10 to capture the radiation beams 24 transmitted through the object 12 and items of interest 14 at different projection angles. In another embodiment, the detector system 22 includes a flat panel array or continuously pixilated array of detectors that may provide a desirable angular sampling. Although the illustrated embodiment depicts a tomography system with one beamline, other embodiments may include tomographic imaging systems with two, three, or more beamlines, wherein two of the beamlines are orthogonal to each other, or other configurations of beamlines where two or more beamlines are used and the multiple beamlines are not mutually orthogonal. In one embodiment, a single detector system may capture radiation from two or more sources. In yet another embodiment, each beamline has a dedicated source and detector system. In another embodiment, a single array of detectors may be employed. Although not explicitly mentioned, combinations of one, two, or more beamlines, which utilize single or multiple detector systems, are envisioned.

A processor 28 is further coupled to the detector system 22 to generate projection images and a three dimensional image of the object 12 and the one or more items of interest 14 based upon the radiation beams 24. The processor 28 calculates an attenuation coefficient of the items of interest 14 and further determines multiple parameters representing a composition and volume of the one or more items of interest 14 based upon the attenuation coefficient. Non-limiting examples of the parameters include density, atomic number, size, shape and mass of the one or more items of interest 14.

In operation, the processor 28 receives one or more signals 32 to generate one or more projection views from the one or more signals 32. The processor 28 further reconstructs one or more 3D images from the two or more projection views. As used herein, each 3D image is typically configured as a set of planar slices that are parallel to each other, which represent the object 12 and items of interest 14. In one embodiment, only images from a single beamline are used in the reconstruction of each 3D image. In another embodiment, projection images from two or more beamlines are used to form one or more reconstructed 3D images. The processor 28 may also create a reformatted 3D image from the one or more reconstructed 3D images, such that the slice orientation in the reformatted 3D image is different than the slice orientation in the original 3D image. In one embodiment, the slice orientation of at least one of the reconstructed and the reformatted volume is essentially orthogonal to one beamline. In yet another embodiment, oblique reformats or non-planar slices (e.g., curved surfaces) may be used, either in a reconstructed or a reformatted 3D image. The processor 28 may also be configured to produce volume renderings (i.e., visualizations of the 3D structure, maximum intensity projections, etc.) of the one or more 3D images, or regions of interest of the 3D image, where the viewing direction of the volume may be variable. The processor 28 may also be configured to produce processed images, wherein the processing may consist of thresholding, contour extraction, noise reduction, edge enhancement, extraction of edges, segmentation, computation of the effective atomic number z_eff, as well as other processing steps known in the art. The processed images may also contain contour or other location information only, or other sparse characteristics of the processed image. These processed images may be generated by applying these processing steps to the projection images and/or the reconstructed/reformatted/rendered 3D images, including individual slices and regions/volumes of interest. The system 10 may also include an operator workstation 29 coupled to the processor 28 to display at least one image of the object 12 and the one or more items of interest 14. One or more cine loops of images of at least one of multiple projection views or multiple reconstructed or reformatted 3D slices or volume renderings are displayed. As used herein, the term ‘cine loops’ refers to displaying multiple images (projection views, slices of reconstructed images, slices of reformatted images, and/or volume renderings of reconstructed images, e.g., with varying orientation throughout the display loop, or processed images) sequentially, repeating as necessary so that the person reviewing the images can assess of the nature of objects being scanned. It may also be referred to as a sequence of images presented one after the other in rapid succession, for example, at 30 images per second. Similarly, the term ‘projection view’ refers to a single 2D X-ray image of the object, acquired from any one of the source/detector combinations. The cine loops of images may be presented in different ways, as discussed herein below. The operator workstation 29 may also be used to display a rendered image of the object 12, as well as various other images and additional information. In one example, the rendered image includes one or more of a full resolution image or a reduced resolution image or a zoomed image.

In a particular embodiment, two or more cine loops of images (i.e., slices of a 3D image or projection views) from the one or more beamlines may be displayed simultaneously in a combined image. These two or more cine loops may correspond to images from one beamline (e.g., a cine loop of projection views displayed simultaneously with a cine loop of 3D slices), or they may correspond to images (projection views or reconstructed, reformatted, or rendered images) from two or more beamlines. In another embodiment, one or more cine loops of images of one beamline may be displayed simultaneously with one or more baseline images. The term ‘baseline image’ refers to a static image (as opposed to a cine loop), and may consist of one of the multiple projection views (2D image) obtained; a volume rendering of at least one of the 3D images reconstructed from the multiple projection views; a rendering of a slab of slices; a single slice (axial image, coronal image, sagittal image, oblique reformat, or curved-surface reformat) of a 3D reconstructed image, or a reformatted or a processed image, obtained from the imaging system 10. The baseline image may correspond to an image from the same beamline or from a different beamline than the images displayed in the cine loop. In one embodiment, the central projection of a beamline is used as the baseline image. In another embodiment, the baseline image is selected by the operator, e.g., by selecting a suitable image. In another embodiment, the baseline image may be selected by the operator, for example by navigating through a cine-loop, e.g., by stepping forward or backward through a cine loop, or by stopping a cine loop at the selected image. In that way, a projection image, reconstructed slice, reformatted data, processed image, or volume rendering may be selected that is most useful in helping the operator to interpret the contents of the imaged baggage, and to place the other displayed images and/or cine loops in context. It should be noted that, if the baseline image is part of a cine loop, the baseline image display may be toggled between static image mode and cine loop mode. In yet another embodiment, cine loops and/or renderings are produced for the entire object 12. In another embodiment, cine loops and/or renderings for one or more items of interest 14 are produced.

Simultaneously displaying a baseline image may comprise displaying a combined image in which the cine-loop is superimposed on the baseline image, or displaying a combined image in which the cine loop is displayed adjacent to the baseline image, or providing a display in which the cine-loop and the baseline image are toggled. A combined image, as used herein, refers to a simultaneous display of two or more of a cine-loop or a baseline image, which may be displayed adjacent to each other, superimposed, in temporal succession (e.g., enabled by toggling between the two of more images), etc. Other images or other information may be displayed in addition to the combined image. Multiple combined images may be displayed at the same time. As such, the combined image includes at least a first component and a second component, wherein the first component and the second component each comprise one of a baseline image or the one or more cine loops of images.

It should be noted that embodiments of the invention are not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art.

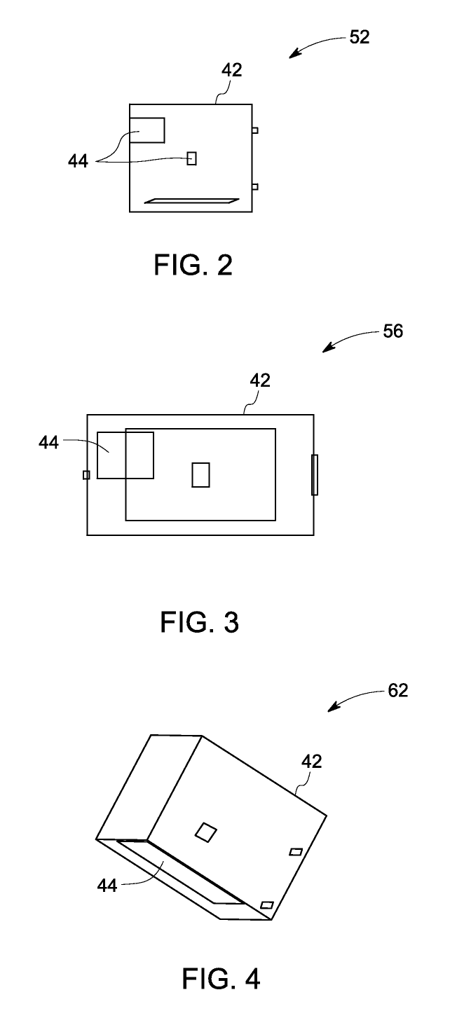

FIGS. 2-4 are schematic illustrations of an exemplary object imaged using the system 10 in FIG. 1. Specifically, the object is imaged along a first beamline direction to generate a projection image; bounding surfaces of projected items of interest are shown in FIG. 2. Similarly, the object is imaged along a second beamline direction that may be orthogonal to the first beamline direction to generate a projection image; bounding surfaces of projected items of interest are shown in FIG. 3. A volume rendering of the object is provided in FIG. 4. In the illustrated embodiment, the object 42 is a baggage with items of interest 44 within the baggage. The object 42 may be equated to the object 12 in FIG. 1. The contents 44 may also be referred to as ‘items of interest’ 14 in FIG. 1. The baggage 42 is imaged from a first beam line, for example beamline 19 in FIG. 1, to produce one or more projection images 52. Similarly, one or more projection images 56 are produced by imaging the baggage along a second beamline, which may be orthogonal to the direction of the beamline 19 (FIG. 3). Furthermore, a volume rendering is performed to generate an image 62 and enable an operator to inspect the baggage with a 3D perspective (FIG. 4). In one embodiment, the volume rendering is performed such that the image 62 displays only an outline of the baggage and regions of interest. In another embodiment, critical parameters of items of interest within the baggage, such as, but not limited to, density, volume, mass, effective atomic number, and basis material content are obtained. In an example, the display of such information may be initiated by selecting an item of interest with the mouse. In another embodiment, indication of threat regions such as, but not limited to, explosives, knives, guns, timers, wires, may be displayed. In one embodiment, this information may be displayed superimposed (at the correct location) on one or more of the displayed images. In another embodiment, only the location of the one or more items of interest is displayed (e.g., as a contour, or a color overlay), and additional information is displayed in a separate region of the operator display. In a preferred embodiment, the indications are color-coded. In yet another embodiment, high-resolution and low-resolution images of regions of interest are provided. In one embodiment, features are provided by a zooming and panning operation on one or more of the displayed baseline images and/or cine loops. The different features described herein may be provided at a request of the operator. In one embodiment, wherein multiple images are displayed, a position indicator is included that identifies a selected location of a cursor in one image and displays the location in the other images, enabling the operator to interpret relative location of objects in the images.

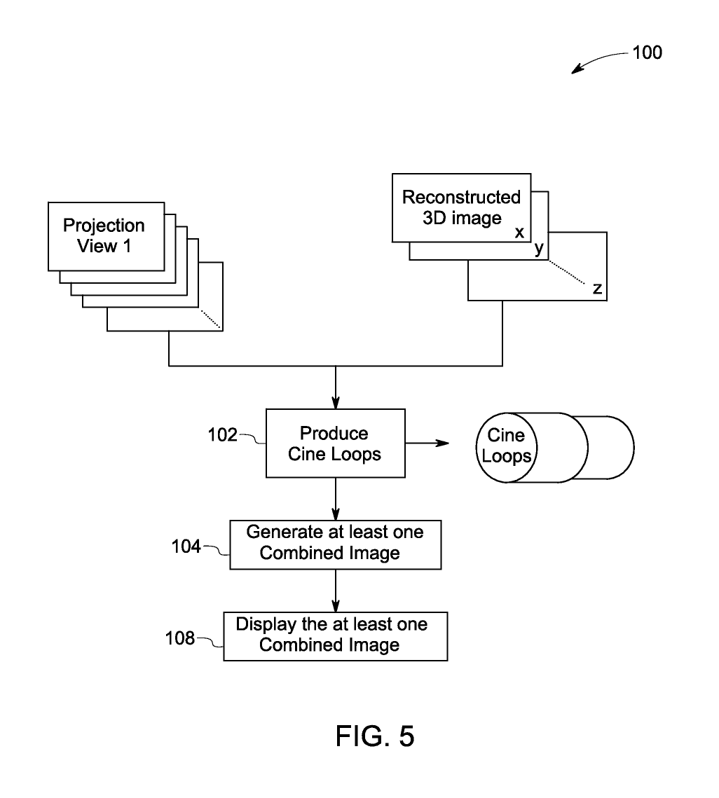

FIG. 5 is a flow chart representing an exemplary method 100 for presenting images of an item of interest. The method 100 includes producing one or more cine loops of images of at least one of a plurality of projection views, multiple reconstructed 3D images, multiple reformatted images, or multiple processed images in step 102. In a particular embodiment, the cine loops of images are produced for a full image of the object. In another embodiment, the cine loops of images are produced for one or more regions of interest of the object. In yet another embodiment, the reconstructed images include one or more of reconstructed slices, reformatted slices, volume rendered images, or processed images. In another embodiment, the cine loops of images represent a 3D volume of the object. A combined image, including a first component and a second component, wherein the first component and the second component each include one of a baseline image or the one or more cine loops of images. The combined image is generated via at least one of superimposing the first component and the second component, displaying the first component adjacent to the second component, toggling between the first component and the second component, in step 104. In yet another embodiment, the combined image include utilizing one or more of a full resolution baseline image, a reduced resolution baseline image, a zoomed baseline image, or cine loop. In another embodiment, the combined image is displayed by allowing an operator to stop the cine loops for the one or more beamlines at an instant of time and view the baseline image for the respective beamlines. In another embodiment, the resulting image is displayed by allowing an operator to toggle between the beamlines. In yet another embodiment, the operator may be able to manually step through a sequence and/or select a specific view. In another embodiment, the toggling includes automatic toggling or an operator-controlled toggling. In still another exemplary embodiment, the one or more beamlines exist in a dual-energy imaging system. Finally, at least one combined image is displayed in step 108.

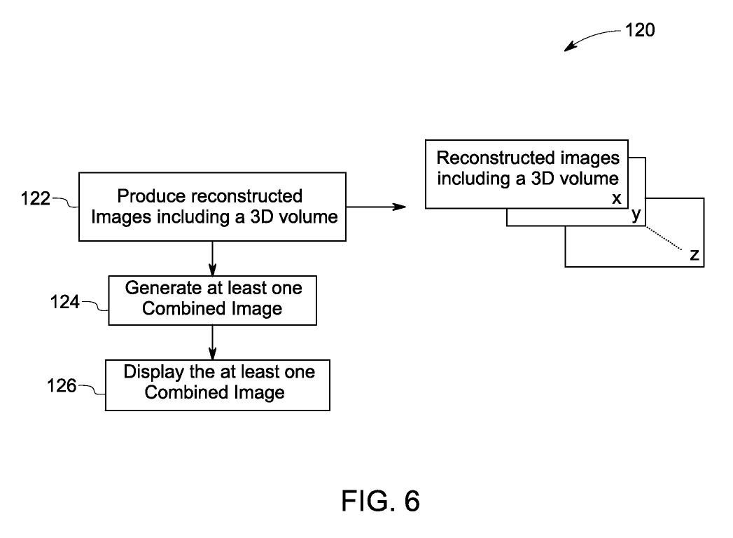

FIG. 6 is a flow chart representing steps in another exemplary method 120 for presenting images of an item of interest. The method 120 includes producing multiple reconstructed images including a 3D volume for one or more beamlines in step 122. In one embodiment, a full image of the object is produced. In another embodiment, images of one or more regions of interest of the object are produced. A combined image, including a first component and a second component, wherein the first component and the second component each include one of a baseline image or the multiple reconstructed images is generated via at least one of the following methods in step 124. In one embodiment, the first component and the second component are superimposed. In another embodiment, the first component is displayed adjacent to the second component. In another embodiment, the first component and the second component are toggled between. In one embodiment, the combined image being displayed is toggled between the reconstructed images including a 3D volume generated from one or more beamlines. In another embodiment, the beamlines exist in a dual-energy imaging system. At least one combined image is further displayed in step 126. In one embodiment, the combined image is displayed by utilizing one or more of a full-resolution, a reduced-resolution, or a zoomed baseline image or the plurality of reconstructed images including the 3D volume. In another embodiment, one of the entire 3D volume of the object or a region of interest of the object is displayed.

The various embodiments of a system and method for presentation of tomosynthesis imaging as described above thus provide a convenient and efficient means to prevent security incidents from occurring. The enhanced display of information from tomosynthesis imaging provides increased detection capability for items of interest such as, but not limited to, contraband, special nuclear materials, and explosives. The systems and techniques described above facilitate an efficient inspection, together with a reduction of false alarms, consequently reducing expensive and time-consuming secondary inspections of objects. Additionally, the technique presents images of objects of interest to an operator in a manner that enables extraction of relevant information and fast decision making.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the generation of cine loops of images from projection views described with respect to one embodiment can be adapted for use in inspection of a checked luggage. Further, although embodiments of the present invention are described above in reference to its application in connection with and operation of a system incorporating an X-ray scanning system for inspecting cargo crates, pallets, and/or objects, it should apparent to those skilled in the art and guided by the teachings provided herein that any suitable radiation source including, without limitation, neutrons or gamma rays or combination thereof, may be used in alternative embodiments. Similarly, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for presenting images of an object of interest, the method comprising:
producing one or more cine loops of images from at least one of:
a plurality of projection views; or a plurality of reconstructed images comprising a 3D volume obtained from one or more beamlines;
generating at least one combined image comprised of a first component and a second component, wherein the first component and the second component each comprise one of a baseline image or the one or more cine loops of images and the generating comprises at least one of:
superimposing the first component and the second component;
displaying the first component adjacent to the second component;
toggling between the first component and the second component; and displaying the at least one combined image.

2. The method of claim 1, wherein said one or more cine loops is produced from one or more of reconstructed slices, reformatted slices, volume rendered images, or processed images.

3. The method of claim 1, wherein one or more of said baseline images is produced from one or more of reconstructed slices, reformatted slices, volume rendered images, or processed images.

4. The method of claim 1, wherein said producing the one or more cine loops of images comprises producing the cine loops of images representing a 3D volume of the object.

5. The method of claim 1, wherein said producing the one or more cine loops of images comprises producing the cine loops of images for a region of interest of the object.

6. The method of claim 1, wherein said generating the at least one combined image further comprises utilizing one or more of a full-resolution, a reduced-resolution, or a zoomed baseline image or cine loop.

7. The method of claim 1, wherein said generating a baseline image further comprises allowing an operator to stop the display of images in a cine loop at an instant of time and select the corresponding image as a new baseline image.

8. The method of claim 1, wherein said toggling comprises toggling between a baseline image or one or more of the cine loops from one beamline and a baseline image or one or more of the cine loops from the same or another beamline.

9. The method of claim 1, wherein said toggling comprises toggling between baseline images or one or more of the cine loops from a same beamline.

10. The method of claim 1, wherein said toggling is one of automatic toggling or operator-controlled toggling.

11. The method of claim 1, wherein said one or more beamlines exist in a dual-energy imaging system.

12. An imaging system for an object of interest, the system comprising:
a radiation source configured to emit a stream of radiation through the object of interest at a plurality of projection directions;
at least one detector array comprising a plurality of detector elements, wherein each detector element is configured to generate signals in response to respective streams of radiation, and wherein the signals convey information about the object at respective orientation angles of the radiation source and each detector element relative to the object;
a processor coupled to the detector array, the processor configured to:
receive the signals;
generate projection views from the signals;
reconstruct images comprising a 3D volume and slices thereof of the 3D volume, from the projection views;
produce one or more cine loops of images of at least one of a plurality of the projection views or a plurality of reconstructed images comprising a 3D volume obtained from one or more beamlines;
generate at least one combined image comprised of a first component and a second component, wherein the first component and the second component each comprise one of a baseline image or the one or more cine loops of images and the generating comprises at least one of:
superimposing the first component and the second component;
displaying the first component adjacent to the second component;
toggling between the first component and the second component; and an operator workstation configured to display the at least one combined image.

13. The system of claim 12, wherein said producing of the one or more cine loops further comprises producing one or more of the cine loops of one or more of reconstructed slices, reformatted slices, volume rendered images, or processed images.

14. The system of claim 12, wherein the processor is configured to produce one or more cine loops of images comprising a full 3D volume of the object.

15. The system of claim 12, wherein the processor is configured to produce one or more cine loops of images comprising a region of interest of the object.

16. The system of claim 12, wherein the at least one combined image comprises one or more of a full-resolution, a reduced-resolution, or a zoomed baseline image or cine loop.

17. A method for presenting images of an object of interest, the method comprising:
producing a plurality of reconstructed images comprising a 3D volume for one or more beamlines; and
generating at least one combined image comprised of a first component and a second component, wherein the first component and the second component each comprise one of a baseline image or the plurality of reconstructed images comprising a 3D volume and the generating comprises at least one of:
superimposing the first component and the second component;
displaying the first component adjacent to the second component;
toggling between the first component and the second component; and
displaying the at least one combined image.

18. The method of claim 17, wherein said producing the reconstructed images comprises producing images of the entire 3D object.

19. The method of claim 17, wherein said producing the reconstructed images comprises producing images of a region of interest of the object.

20. The method of claim 17, wherein said displaying the at least one combined image comprises utilizing one or more of a full-resolution, a reduced-resolution, or a zoomed baseline image or the plurality of reconstructed images comprising the 3D volume.

21. The method of claim 17, wherein said displaying the at least one combined image comprises displaying one of the entire 3D volume of the object or a region of interest of the object.

22. The method of claim 17, wherein said one or more beamlines exist in a dual-energy imaging system.

23. A system for presenting images of an object of interest, the system comprising:
a radiation source configured to emit a stream of radiation through the object of interest at a plurality of projection directions;
at least one detector array comprising a plurality of detector elements, wherein each detector element is configured to generate signals in response to respective streams of radiation, and wherein the signals convey information about the object at respective orientation angles of the radiation source and detector array relative to the object;
a processor coupled to the detector array, the processor configured to:
receive the signals;
generate projection views from the signals;
reconstruct images comprising a 3D volume and slices thereof of the 3D volume, from the said projection views; and
at least one of superimposing a first component and a second component, displaying the first component adjacent to the second component or toggling between the first component and the second component to generate at least one combined image, wherein the first component and the second component each comprise one of a baseline image or the plurality of reconstructed images comprising a 3D volume and
an operator workstation configured to display the at least one combined image.

24. The system of claim 23, wherein said processor produces a baseline image or a plurality of reconstructed images comprising a 3D volume for the entire 3D object.

25. The system of claim 23, wherein said processor produces a baseline image or a plurality of reconstructed images comprising a 3D volume for one or more regions of interest of the object.

26. The system of claim 23, wherein the processor displays either a full-resolution image, reduced-resolution image, or a zoomed baseline image or a plurality of reconstructed images comprising a 3D volume.

27. A system for presenting images of an object of interest, the system comprising:
a processor coupled to at least one detector array, the processor configured to:
receive one or more signals from a detector array;
generate projection views from the one or more signals;
reconstruct images of the object from the said projection views;
produce one or more cine loops of a plurality of images:
a plurality of the projection views; or
a plurality of reconstructed images comprising a 3D volume; and
at least one of superimposing a first component and a second component, displaying the first component adjacent to the second component or toggling between the first component and the second component to generate at least one combined image, wherein the first component and the second component each comprise one of a baseline image or a cine loop of a plurality of images; and
an operator workstation configured to display the at least one combined image.

28. The system of claim 27, comprising:
a radiation source configured to emit a stream of radiation through the object of interest at a plurality of projection directions; and
the at least one detector array, comprising a plurality of detector elements, wherein each detector element is configured to generate one or more signals in response to respective streams of radiation, and wherein the one or more signals convey information about the object at respective orientation angles of each detector element relative to the object.
